(19) United States
(12) Patent Application Publication
(10) Pub. No.: US 2003/0172072 A1
(43) Pub. Date: Sep. 11, 2003

(54) Method and system for automatically ordering replacement of consumable parts of a system

(76) Inventor: Margaret Paige Smith, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/091,794

(22) Filed: Mar. 6, 2002

(51) Int. Cl. G06F 7/00

(52) U.S. Cl. 707/10

(57) ABSTRACT

A method and a system for automatically ordering replacement of consumable parts of a system. At least one parameter for a part of the system is monitored. The parameter is compared to at least one replacement criterion. A user notification is automatically generated when a comparison of the parameter to the replacement criterion indicates that a replacement part should be ordered. Responsive to a user input or an automatic system control, a replacement part order is automatically communicated to a replacement part order center. The monitored parameter can be a duration of operation, an output level, an input level, an operating temperature, a number of on-off cycles, an oxidation level, a corrosion level, a decomposition level, or a material elasticity level. The order can be transmitted to the replacement part order center through a global computer network, a cable television network, a wireless link, or a dial-up telephone line.

### CROSS REFERENCE TO RELATED APPLICATIONS

Not Applicable

### BACKGROUND OF THE INVENTION

1. Field of the Invention

This invention relates generally to a method and system for selling replacement parts, and more specifically, to a method for facilitating the order process for replacement parts.

2. Description of Related Art

A typical appliance includes components, or parts, that have finite life cycles. These parts generally wear and need periodic replacement for continued operation of the appliance. A consumer usually does not realize a part has reached or is approaching the end of its life cycle until the part fails and the appliance ceases to function properly. When part failure occurs, a consumer typically has two options, repair the appliance or replace the appliance. In the case the consumer chooses to repair the appliance, there is no assurance of the availability of replacement parts. The consumer frequently must wait days or weeks after ordering replacement parts for the replacement parts to arrive. Further, there is no assurance the correct parts will be received or that the best available replacement part will be ordered. The consumer thus can be without the use of the appliance for an appreciable period of time or even operate their appliance with a less than optimum replacement part.

In a liquid crystal on silicon (LCOS) high definition television (HDTV), a lamp assembly is used for illumination rather than a picture tube. This lamp's average life expectancy is approximately 10,000 hours, although the actual operational life can vary from lamp to lamp. There typically is no warning before an LCOS lamp fails. Hence, the consumer typically does not have a replacement lamp on hand in anticipation of lamp failure. Therefore, when the LCOS lamp does fail, the consumer will typically be deprived of the use of the LCOS HDTV until another LCOS lamp is ordered and received. An LCOS lamp is not a common electronic item and therefore is not readily available at a local retail outlet.

Hence, what is needed is a system for use in appliances that will give a warning to a consumer that a part in the appliance will soon need replacement. An added benefit can be provided by a system that facilitates the ordering process to minimize consumer inconvenience.

### SUMMARY

The present invention relates to a method and a system for automatically ordering replacement of consumable parts of a system. A consumable part is any part of a system that will have a tendency to wear out or require replacement after a period of time. The method includes the steps of monitoring at least one parameter for a part of the system, comparing the parameter to at least one replacement criterion for the part, automatically generating a user notification when a comparison of the parameter to the replacement criterion indicates that a replacement part should be ordered and, responsive to a user input or an automatic system control, automatically communicating an order to a replacement part order center for a replacement for the part.

The parameter being monitored can be a duration of operation, an output level, an input level, an operating temperature, a number of on-off cycles, an oxidation level, a corrosion level, a decomposition level, or a material elasticity level. For example, an output level for a light source in a projection display. The order can include order information such as a billing address, a billing account, a shipping address, and a part identification code. The order can be transmitted to the replacement part order center through a global computer network, a cable television network, a wireless link, or a dial-up telephone line.

A system for automatically ordering replacement of consumable parts of a system can include part monitoring means for monitoring at least one parameter for a part of the system, comparator means for comparing the parameter to at least one replacement criterion for the part, notification means for automatically generating a user notification when a comparison of the parameter to the at least one replacement criterion indicates that a replacement part should be ordered and order processing means for automatically communicating an order to a replacement part order center for a replacement for the part.

### BRIEF DESCRIPTION OF THE FIGURES

FIG. 1 is a block diagram of a system having a replacement part order system for the appliances in accordance with the present invention.

FIG. 2 is a block diagram of an HDTV system that interfaces with a replacement part order system and facilitates the order of replacement parts in accordance with the present invention.

FIG. 3 is a flow chart showing the method of implementing a replacement part ordering system on an appliance in accordance with the present invention.

FIG. 4 is a flow chart showing the method of processing a replacement part order in accordance with the present invention.

FIG. 5A is an exemplary replacement part requirement notification in accordance with the present invention.

FIG. 5B is an exemplary replacement part ordering instruction in accordance with the present invention.

FIG. 5C is an exemplary replacement part order confirmation in accordance with the present invention.

FIG. 5D is an exemplary non-order confirmation in accordance with the present invention.

### DETAILED DESCRIPTION

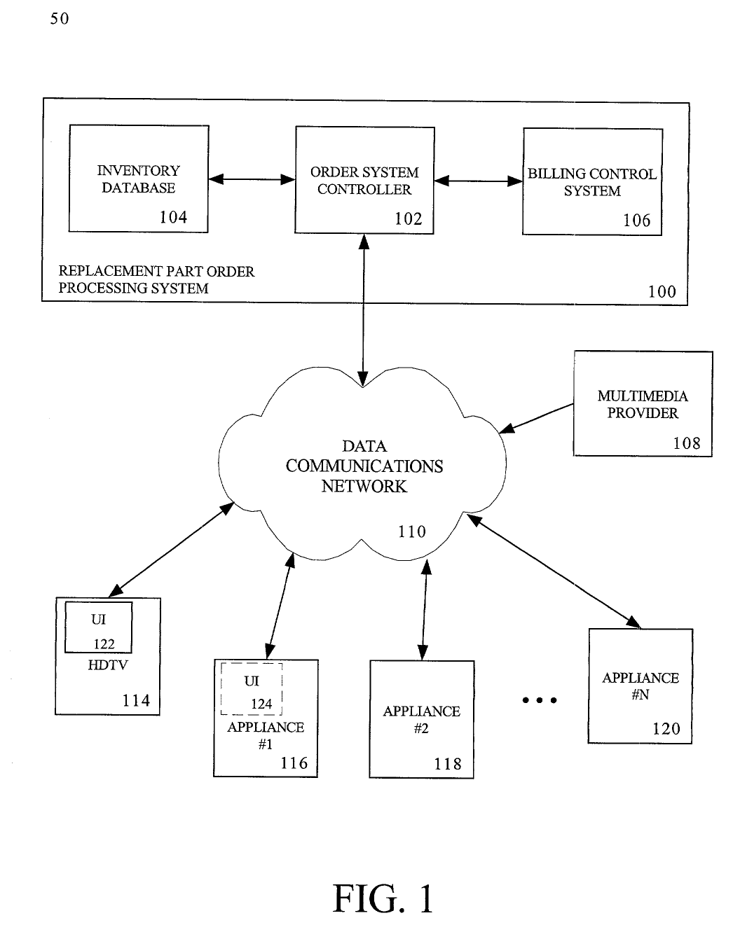

Referring to FIG. 1, a block diagram of a system 50 incorporating appliances and a replacement part order processing system 100 for appliances is shown. The replacement part order processing system 100 can be operated by a replacement part order center remotely located to the appliances. For example, the replacement part order center can be a computer server located in a warehouse in a first geographic region and an appliance being served can be located in a residence of another geographic region.

The replacement part order processing system 100 can include an order system controller 102 that communicates with other system components for processing replacement part orders. The order system controller 102 can include a processing unit and a system bus, not shown. Furthermore, additional devices can be used in the order system controller 102 as well. For example, the order system controller 102 can further include a network interface, a magnetic disk medium, an optical disk medium, an electronic storage medium, analog to digital (A/D) converters, digital to analog converters (D/A) and a user interface (not shown).

A plurality of appliances can utilize the replacement part order system. For example, an HDTV 114 and other appliances, #1-N can utilize the replacement part order system. The appliances can communicate with the replacement part order system via the data communications network 110. The appliances can include user interfaces to facilitate replacement part ordering, for example HDTV 114 can include user interface 122 and appliance 116 can include user interface 124. However, replacement parts can also be ordered automatically without user intervention or the use of a user interface.

The order system controller 102 can include suitable communication for hardware and software for communicating with appliances, for example HDTV 112, appliance #1, appliance #2, etc. to receive replacement part orders and to communicate order verifications. The order system controller 102 can communicate with the appliances over a data communications network 110. The data communications network 110 can be a global computer network, a cable television network, a wireless link, or a dial-up telephone line. For example, the data communications network 110 can be a network operated by a multimedia provider 108 for providing distributed multimedia presentations, such as DirectTv® or a cable television.

The order system controller 102 can receive replacement part orders from appliances 114, 115, 116, 120 and can check the status of the replacement part being ordered. For example, the order system controller 102 can communicate with an inventory database 104 containing part information such as inventory status, lead time, pricing, shipping weight, etc. The order system controller 102 can communicate with the inventory database 104 via internal device communications, for example if the order system controller 102 and the inventory database 104 are located on common device, such as a computer. The order system controller 102 also can communicate with the inventory database 104 via a local area network (LAN), wide area network (WAN), the data communications network 110, or other suitable communications system.

The system also can include a billing control system 106 that verifies account statuses and processes billing for replacement part sales transactions. The billing control system 106 can include a processing unit, device memory and a system bus. However, the billing control system 106 is not thus limited and can include alternate processing devices and methods of internal device communication. Furthermore, additional devices can be used in the billing control system 106 as well. For example, the billing control system 106 can further include a network interface, a magnetic disk medium, an optical disk medium or an electronic storage medium, and a user interface (not shown). The order system controller 102 can communicate with the billing control system 106 via a local area network (LAN), wide area network (WAN), the data communications network 110, or other communications system. In an alternate embodiment the order system controller 102, the billing control system 106 and the inventory database 104 can operate on a single computer or computer system and communicate via internal device communications.

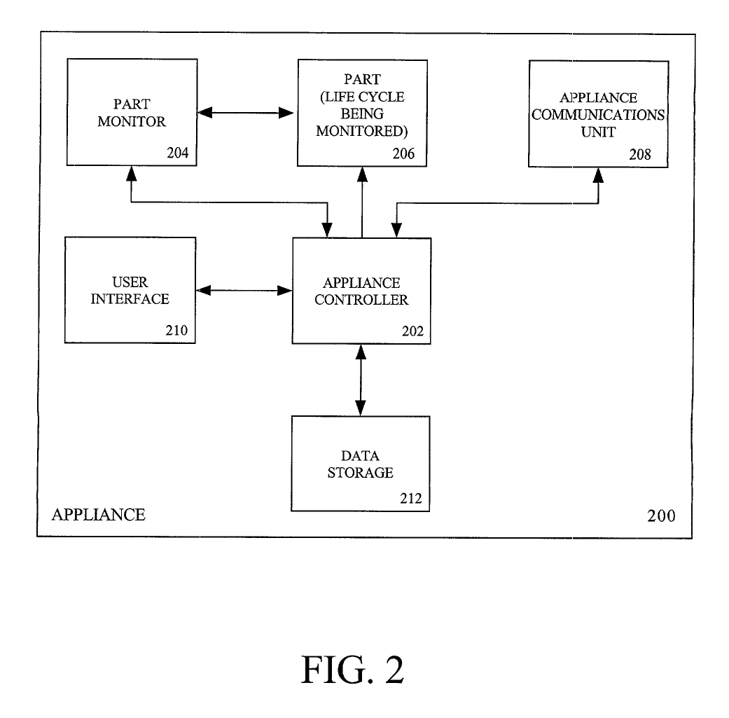

Referring to FIG. 2, a block diagram illustrating replacement ordering components in an appliance 200 is shown. The appliance 200 can be any appliance, including commercial, industrial and home appliances. For example, the appliance 200 can be a television, an oven, a washing machine, a refrigerator, a dryer, a dishwasher, a vacuum oven, a temperature cycling unit, an air compressor, an air conditioning system, a computer, a copier, a printer, a fax machine, etc.

The appliance 200 can include an appliance controller 202 that can communicate with other system components for monitoring parts and for processing replacement part orders. The appliance controller 202 can include a processing unit and a system bus. Additional devices can be used in the appliance controller 202 as well. For example, the appliance controller 202 can further include random access memory (RAM), read only memory (ROM), analog to digital (A/D) converters, digital to analog converters (D/A), sensor interfacing devices and timing devices. Data storage 212, either integral with the appliance controller 202 or external to the appliance controller 202, can also be provided. For example, data storage 212 can be a common storage medium, for example a magnetic disk medium, an optical disk medium or an electronic storage medium.

A part monitor 204 can be incorporated into the appliance 200 to monitor at least one part 206. The part monitor 204 can be incorporated into the appliance controller 202, can be a discrete component, or both. It should be understood within contemplation of the present invention that multiple parts can be monitored. The part monitor 204 can be any monitoring device or plurality of monitoring devices.

Parts that can be monitored are consumable parts that have a tendency to wear out or that require periodic replacement. For example, belts, hoses, wires, picture tubes, lamps, motors, pumps, compressors, fluids, structures, etc. Examples of part monitors can include thermocouples that monitor operating temperature, counters that measure the number of cycles, timers that measure duration of operation, or sensors that measure any other measurable parameters, such as an output level, an input level, an oxidation level, a corrosion level, a decomposition level, a material elasticity level, level of illumination, average light intensity, average temperature, or component wear.

A measured parameter can be compared to a replacement criterion to determine when a part should be replaced. The replacement criterion can be stored in data storage 212. The comparison can be performed by the appliance controller 202 or by a discrete component, for example another processor, analog comparator or digital comparator. Nevertheless, the invention is not thus limited to the examples contained herein. It would be understood by a skilled artisan that numerous other parts beyond the examples contained herein may be monitored and numerous other devices beyond the examples contained herein may be used to monitor parts and compare measured parameters to replacement criterion.

In one example, if the part being monitored is a lamp for an LCOS display in an HDTV, the part monitor can be a timer that measures the duration of operation of the LCOS display or the lamp itself and forwards a duration value to the appliance controller 202. A criterion can be stored in data storage 212 to trigger a notification to a user when the LCOS display has been used for a certain number of hours. The lamp usage criterion can also be based on a number of on-off cycles or other various weighted parameters that account for other factors effecting the life span of the lamp.

The appliance can further include a user interface 210. For example, if the appliance is a television an interactive user interface can be incorporated. The interactive user interface can include a display, a remote control unit, a keypad, buttons, a touch screen, voice recognition, tactile recognition, etc. In another example the appliance can be a refrigerator and the user interface 210 can include a display and buttons or a keypad. Still, numerous other types of user interfaces can be provided, as would be known to the skilled artisan.

Appliance communication unit 208 can be provided for communications between the appliance 200 and the replacement part order processing system 100. For example, the appliance communications unit can be a device for interfacing or communicating with a global communications network such as the Internet, a cable television network, a wireless link, a telecommunications network, or a satellite communications network. Accordingly, the appliance communications unit can be wired or wireless. For example, if the appliance is connected to a cable television network, the appliance communications unit 208 can be a cable modem. If the appliance is connected to a DirectTV® network, the appliance communications unit can be the DirectTV® transceiver and satellite dish. If the appliance is connected to a telecommunications network, the appliance communications unit can be a dial-up modem.

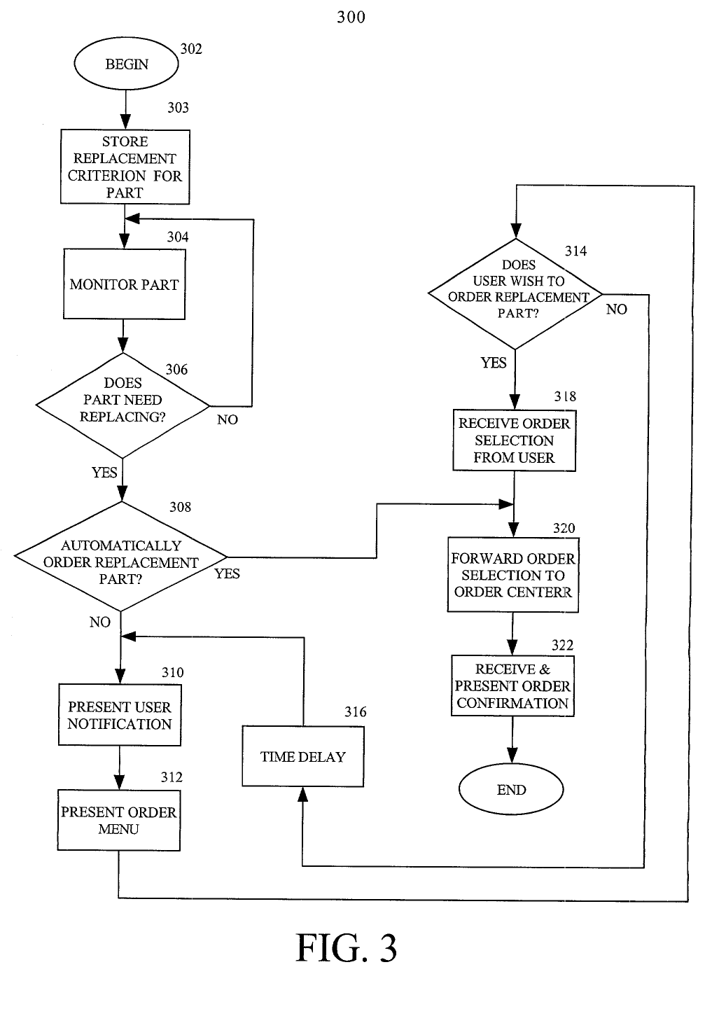

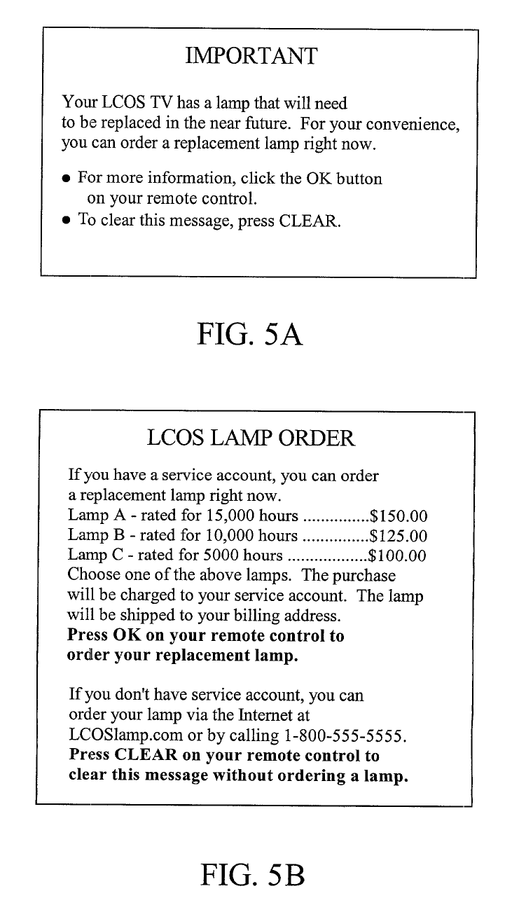

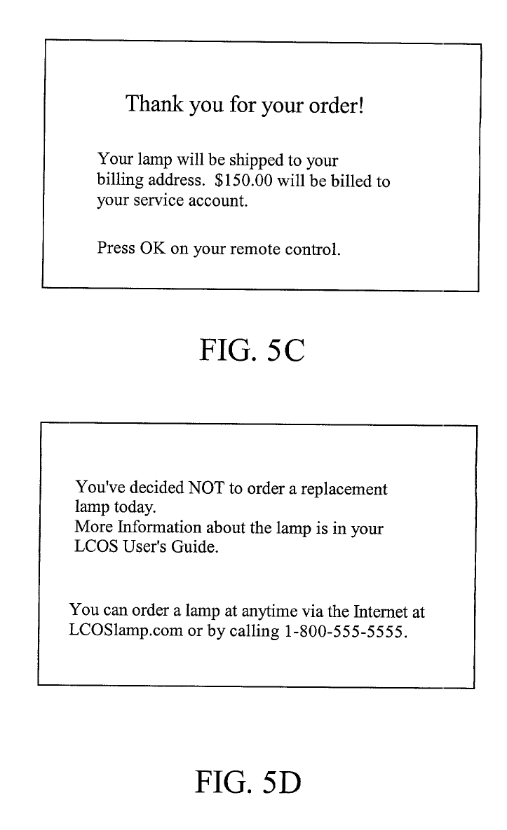

Referring to FIG. 3, a flow chart 300 illustrating the method of implementing a replacement part ordering system on an appliance is shown. For illustrative purposes the process shown is for ordering a single replacement part. However, multiple replacement parts can be ordered via the process as well. The process begins at step 302. At step 303, at least one predetermined criterion can be stored for a particular component or part of an appliance. Referring to step 304 and decision block 306, the use of a part 206 in an appliance 200 (see FIG. 2) can be continually monitored by a part monitor 204 until the part needs to be replaced. In particular, a criterion indicating a condition, state or life cycle of part 206 can be measured or calculated by part monitor 204. In step 306, a measured parameter can be compared to the predetermined replacement criterion to determine whether the part is measuring the end of its useful life. When the part 206 needs to be replaced, a replacement part can be automatically ordered as shown in decision block 308. Otherwise the appliance controller 202 can generate a part replacement notification to the user notifying the user that the part needs to be replaced, as shown in step 310. The part replacement notification can be communicated from the appliance controller 202 to the user interface 210. For example, a part replacement notification as shown in FIG. 5A can be presented to a user by displaying the notification on a television screen.

A replacement part order menu also can be presented, as shown step 312 of FIG. 3. FIG. 5B shows an example of an order menu that can be presented. The order menu can provide the user with the price of the replacement part, billing and shipping information, contact information, or any other information or multiple valid options for replacing the existing part. The appliance controller 202 can communicate with the replacement part order system 100 via the appliance communications unit 208 to order the replacement part. The order menu also can provide the user with an option to proceed with the order, to cancel the order process or to have a sales representative contact the user. It should be noted, however, that the invention is not limited to the type of notifications and menus that are presented to the user, or to the manner in presenting the notifications.

Referring to decision block 314, if the user decides not to order, a non-order confirmation can be presented to the user. FIG. 5D shows an exemplary non-order confirmation. Further, a time delay can be implemented prior to presenting a next part replacement notification to the user, as shown in step 316 of FIG. 3. For example, a part replacement notification can be presented when the duration of use for an LCOS lamp reaches 9,000 hours. If the user decides not to order a replacement lamp at that time, a time delay can be implemented to remind the user again in 1 week, and the cycle can repeat itself until either the part being monitored 206 fails or the part 206 is replaced. Alternatively, the delay can be based on the component usage. For example, when the duration of use for an LCOS lamp has increased an additional 1,000 hours. Nevertheless, there are a variety of other parameters that can be monitored to determine the time delay.

Referring to step 318, if the user decides to order a replacement part, the order can be received by the appliance controller 202 forwarded to the replacement part order system 100 via the appliance communications unit 208, as shown in step 320. The order can include a part identification code, such as part number, quantity and description of the part being ordered, billing account information, shipping information and any other information the order center requests. Referring to step 322, the appliance controller 202 can receive an order confirmation from the replacement part order system 100 and present the order confirmation to the user. FIG. 5C is an exemplary order confirmation providing billing and shipping information. It should be noted that that this system can essentially assure the owner of the appliance that she will receive the correct replacement part. Furthermore, this system also can provide the user with the opportunity to purchase higher quality or higher-grade replacement parts that become available over the lifespan of the appliance. For example, if a new lamp for an LCOS projection system having a lifespan of 20,000 hours becomes available as a suitable replacement for an existing lamp, the replacement part order processing system 100 can communicate this information (via the data communications network 110 and appliance communications unit 208) and present it as an option to the user through the user interface 210.

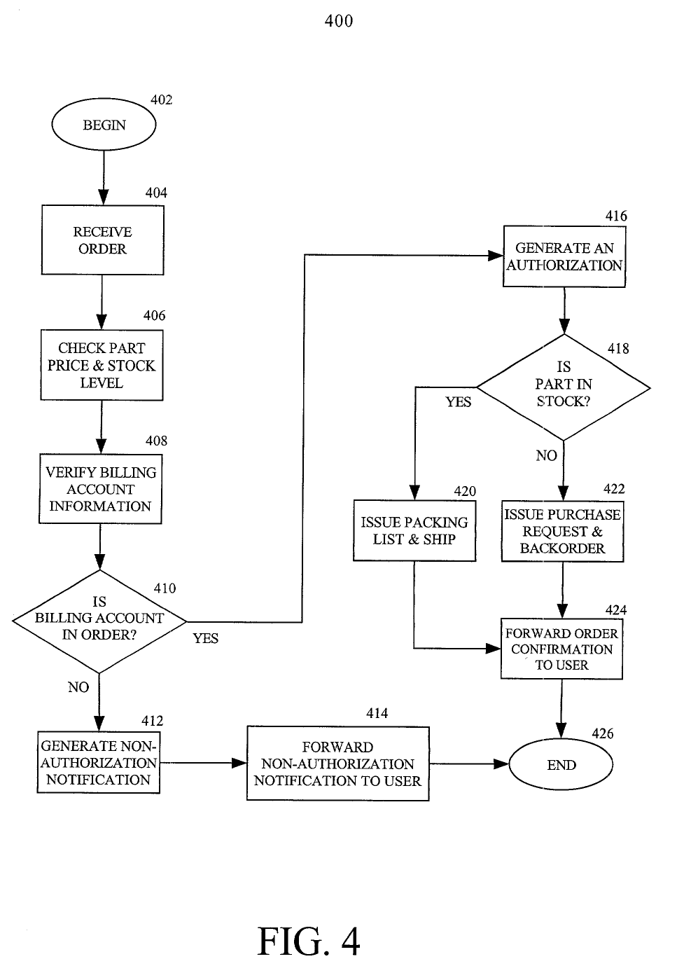

Referring to FIG. 4, a flow chart 400 for processing a replacement part order is shown. The process begins at step 402. For illustrative purposes the process shown is for processing an order for a single replacement part. However, multiple replacement parts can be processed in a single order and multiple orders can be processed simultaneously. Referring to step 404, the replacement part order processing system 100 can receive the order. The order can include a part identification code for each part ordered. Additionally, the order can include a billing address and a shipping address if these are not on file or if they differ from the addresses on file. After being received, the order can be directed to the order system controller 102. The order system controller 102 then can communicate with the inventory database 104 to verify the price and the stock level of the part being ordered, as shown in step 406. The order system controller 102 also can communicate with the inventory database 104 upon request by an appliance in order to forward updated part information to the appliance prior to an order being placed.

Referring to step 408, the order system controller can communicate with the billing control system 106 to verify billing account information. In one embodiment, a user can have an established billing account, for example with the multimedia provider 108, and the user can use this billing account for payment processing when purchasing a replacement part. Referring to decision block 410, the billing control system 106 can verify whether the billing account is in order, for example that there is a billing account established for the user, that charges for replacement parts against the account are authorized, and that the billing account is current. If a billing account is established for the user, charges for replacement parts are authorized and the billing account is current, the billing control system 106 can communicate an authorization to the order system controller 102, as shown in step 416.

In an alternate embodiment, the order system controller 102 can receive banking account information or credit card information from a user and forward this information to the billing control system 106 for processing. The billing control system 106 can communicate with a bank or other financial institution to process the financial aspects of the transaction. The billing control system 106 can forward an authorization to the order system controller 102 when the financial aspects of the transaction are complete.

The authorization notifies the system controller 102 that the transaction may be completed. If replacement part charges are not authorized, the billing account is not current, or a billing account cannot be found for the user, the billing control system 106 can generate a non-authorization notification, as shown in step 412, and forward the non-authorization notification to the order system controller 102 to notify the user that the transaction is not authorized, as shown in step 414.

Referring to decision block 418, if the order system controller 102 receives an authorization, it can determine whether the ordered part is in stock based on the part information received from the inventory database 104. If the ordered part is in stock, the order system controller 102 can issue a packing list for the ordered part to be shipped, as shown in step 420. If the ordered part is not in stock, the order system controller can issue a purchase request and place the ordered part on backorder, as shown in step 422. An order confirmation that gives the status of the order then can be forwarded to the user, as shown in step 424. The order confirmation can notify the user of the inventory status of the ordered replacement part, the anticipated shipping date, and billing charges. If the transaction was not authorized by the billing control system, a non-authorization notification can be forwarded to the user. The order confirmation or non-authorization notification can be forwarded to the appliance over the data communications network 110 for presentation to the user. Alternatively, the order confirmation or non-authorization can be forwarded by e-mail, postal service or other communication.

It should be understood that the examples and embodiments described herein are for illustrative purposes only and that various modifications or changes in light thereof can be suggested by persons skilled in the art and are to be included within the spirit and purview of this application. The invention can take many other specific forms without departing from the spirit or essential attributes thereof for an indication of the scope of the invention.

What is claimed is:

1. A method for automatically ordering replacement of consumable parts of a system, comprising the steps of:
monitoring at least one parameter for a part of said system;
comparing said parameter to at least one replacement criterion for said part;
automatically generating a user notification when a comparison of said parameter to said at least one replacement criterion indicates that a replacement part should be ordered; and,
responsive to at least one action selected from the group consisting of a user input and an automatic system control, automatically communicating an order to a replacement part order center for a replacement for said part.

2. The method according to claim 1 wherein said communicating step is further comprised of communicating to said replacement part order center at least one of a billing address, a billing account, a shipping address, and a part identification code.

3. The method according to claim 1 wherein said communication step is further comprised of transmitting said order to said replacement part order center through at least one of a global computer network, a cable television network, a wireless link, and a dial-up telephone line.

4. The method according to claim 1 wherein said parameter for said part is selected from the group comprising a duration of operation, an output level, an input level, an operating temperature, a number of on-off cycles, an oxidation level, a corrosion level, a decomposition level, and a material elasticity level.

5. The method according to claim 1 wherein said parameter for said part is an output level for a light source.

6. The method according to claim 1 wherein said system is a projection display and said part is a light source.

7. The method of claim 1 wherein said replacement part order center is a computer server.

8. A method for automatically ordering replacement of consumable parts of an appliance, comprising the steps of:
monitoring at least one parameter for a part of said appliance;
comparing said parameter to at least one replacement criterion for said part;
automatically generating a user notification on a display when a comparison of said parameter to said at least one replacement criterion indicates that a replacement part should be ordered;
responsive to at least one action selected from the group consisting of a user input and an automatic system control, presenting an order menu on said display, said order menu comprising at least one replacement part order option; and,
responsive to at least one action selected from the group consisting of a user input and an automatic system control, automatically communicating an order to a replacement part order center for a replacement for said part.

9. A system for automatically ordering replacement of consumable parts of a system, comprising:
part monitoring means for monitoring at least one parameter for a part of said system;
comparator means for comparing said parameter to at least one replacement criterion for said part;
notification means for automatically generating a user notification when a comparison of said parameter to said at least one replacement criterion indicates that a replacement part should be ordered; and,
order processing means responsive to at least one action selected from the group consisting of a user input and an automatic system control, for automatically communicating an order to a replacement part order center for a replacement for said part.

10. The system according to claim 9 wherein said order processing means communicates to said replacement part order center at least one of a billing address, a billing account, a shipping address, and a part identification code.

11. The system according to claim 9 wherein said order processing means transmits said order to said replacement part order center through at least one of a global computer network, a cable television network, a wireless link, and a dial-up telephone line.

12. The system according to claim 9 wherein said parameter for said part is selected from the group comprising a duration of operation, an output level, an input level, an operating temperature, a number of on-off cycles, an oxidation level, a corrosion level, a decomposition level, and a material elasticity level.

13. The system according to claim 9 wherein said parameter for said part is an output level for a light source.

14. The system according to claim 9 wherein said system is a projection display and said part is a light source.

15. The system according to claim 9 wherein said replacement part order center is a computer server.
